(19) United States
(12) Patent Application Publication
(10) Pub. No.: US 2008/0243558 A1
(43) Pub. Date: Oct. 2, 2008

(54) System and method for monitoring driving behavior with feedback

(76) Inventor: Ash Gupte, Hillsboro, OR (US)

Correspondence Address: ATER WYNNE LLP, 222 SW COLUMBIA, SUITE 1800, PORTLAND, OR, 97201-6618, US

(21) Appl. No.: 12/079,837

(22) Filed: Mar. 27, 2008

Related U.S. Application Data
(60) Provisional application No. 60/920,516, filed on Mar. 27, 2007.

(51) Int. Cl. G06Q 40/00; G08B 23/00

(52) U.S. Cl. 705/4; 340/576

(57) ABSTRACT

In accordance with an embodiment of the present invention, a network system for monitoring driving behavior comprises one or more vehicle-mountable motion sensing mechanisms that generate a plurality of data relevant to vehicle moving attitude. The data being indicative of manual or mental risks for a vehicle operator is wirelessly transmittable. The network system also comprises a central data processing system that collects the data transmitted from the motion sensing mechanisms. A risk assessment engine operatively coupled to the central data processing system analyzes the collected data to determine the manual or mental risks. The central data processing system further comprises a feedback engine operable to yield indicia based on the analyzed data that is reportable to the vehicle operator or an authorized data recipient. A reward engine operatively coupled to the feedback engine provides incentives to encourage good or improved driving behavior.

### RELATED APPLICATIONS

This application claims the benefit of priority to U.S. Provisional application No. 60/920,516, filed on 27 Mar. 2007 and entitled DRIVING BEHAVIOR ANALYSIS, REPORT AND REWARD SYSTEM, the contents of which are hereby incorporated herein in their entirety by this reference.

### FIELD OF THE INVENTION

The invention relates generally to the field of vehicle driving. More particularly, the invention relates to system and apparatus that monitor, analyzer and report driving behaviors, as well as reward good driving behavior.

### BACKGROUND OF THE INVENTION

In today's world, millions of cars, trucks, and other land vehicles run on the U.S. roadways at any moment. The operators of those millions of vehicles are currently advised to drive defensively—constantly using the side and rear mirrors and other surveillant devices to observe other drivers' driving behavior. There is no mirror or any other reflecting devices, however, that would capture and feedback and thus assist those vehicle operators to monitor their own driving behavior.

U.S. Patent Application Publication No. US 2005/0256640 A1 to Sigurdsson et al. published Nov. 17, 2005 and titled METHOD AND SYSTEM FOR DETERMINING A TRACK RECORD OF A MOVING OBJECT describes one such vehicle data gathering and processing system that uses GPS coordinate data and mathematical formulaic data processing to determine the global position of a vehicle and to calculate in real time other variables such as speed, acceleration and centripetal acceleration. The disclosure of that publication is incorporated herein in its entirety by this reference. The shortcomings of the invention described therein is that it does not teach how to give meaningful feedback to the driver of the vehicle thus to affect driving behavior also in real time, and that it does not teach how to positively reinforce, e.g. reward, good driving behavior. This patent publication's brief reference to insurance at paragraph [0053] does not enable any lowering of an “insurance fee”, and teaches its limited application to teenage drivers only.

The core issue associated with the existing driving behavior monitoring systems is that the systems primarily implement penalty-oriented policies that aim at post-trauma remedies. There is no mechanism in current systems that provide instant real-time driving behavior monitoring, by which to warn or penalize bad driving behavior as well as to encourage and reward good or improved driving behavior. A lack of an effective real time monitoring system is responsible for the human cost and the heavy financial burdens that have been put on our economy under the current insurance and/or law enforcement systems. This everlasting problem is targeted by the present invention that facilitates risk prevention.

### BRIEF DESCRIPTION OF THE DRAWINGS

FIG. 1 is a system block diagram utilizing alternative Global Positioning Satellite (GPS) or vehicle-mounted sensors for driving behavior data collection.

FIG. 2 is a schematic block diagram of a risk assessment engine that forms a part of the system of FIG. 1.

FIG. 3 is a schematic block/flow diagram of a driver's insurance pricing structure engine that forms a part of the system of FIG. 1.

FIG. 4 is schematic block diagram of a dynamic feedback/reward engine that forms a part of the system of FIG. 1.

### DETAILED DESCRIPTION OF THE PREFERRED EMBODIMENTS

The invention in accordance with a preferred embodiment involves monitoring a vehicle's position, direction and acceleration as an indicator of driving behavior, with a view to reporting back to the driver or forward to data centers and possibly rewarding good driving behavior. Global Positioning System (GPS) equipment can be used to collect vehicle positional data in real time. Alternatively, on-vehicle accelerometers or other positional and/or orientational and/or directional and/or rate of change devices can be used to collect data. Raw or pre-processed data can be wirelessly relayed, e.g. via satellite in accordance with any suitable protocol, e.g. GPRS or WiFi or the like, to the data collection centers for (further) processing, e.g. analysis, recording, reporting, rewarding, etc.

The present invention solves these problems by providing further data processing locally within the vehicle and/or at a central data processing center that aids in giving real-time feedback and potential real-time rewards to good drivers. In accordance with the invention, a driver's insurance premiums can be reduced to provide a monetary incentive to the driver to drive safely and wisely. Alternatively, the driver can be given real-time feedback as by a dashboard-mounted display whether his or her driving is deemed safe, ecological and/or economical. Moreover, nearly continuous data logging and recording and long-term trend analysis can be performed for a monitored driver and thus long-term improvements in driving skill, experience, smoothness, etc. can be notated to the driver by his or her insurance company.

Frequent or excessive acceleration is often an indicator of start-stop and/or braking and/or steering behaviors that are deemed bad. Moreover, the same acceleration excesses are known to increase gasoline consumption and to increase hydrocarbon emissions from the vehicle's tailpipe. As such, acceleration excesses not only increase the cost per mile of driving but also reduce fossil fuel reserves and increase pollution and global warming. If such bad driving behavior can be curtailed, as by simple awareness by the driver that he or she is being monitored, or as by providing real-time feedback to the driver of such excessive acceleration or other bad driving, or as by rewarding the driver somehow for good driving, driving costs as well as ecological and environmental damage can be abated.

Other benefits of monitoring, analyzing, reporting and rewarding good driving follow from use of the present invention. Fewer and/or less severe accidents can result from improved driving, e.g. lowered speeds and full stops at traffic control devices. Thus the health and safety of the driver can also improve and the cost of accidental health care can be reduced. The growing vehicle mortality rate can be abated.

These benefits and others of course are amplified when multiple drivers are so monitored, analyzed, reported and rewarded. Fleets of commercial vehicles, e.g. trucks, can be monitored, analyzed, reported and rewarded in real time so that drivers on the one hand and fleet managers and executives on the other are more aware of driving behavior. When the public is made aware that certain commercial vehicle fleet operators utilize the system, e.g. national overland couriers such as UPS® (which has 55,000 trucks on United States roads at any moment), the public will appreciate the social awareness and safety and ecology consciousness of the company operating the fleet.

Insurance companies, whether pure-play or serving a mix of monitored and unmonitored customers, can be persuaded to lower premiums for drivers who demonstrably improve over time or who are demonstrably good and safe drivers. This is because insurance companies understand that the actuarial statistical probabilities of liability claims against a policy of insurance are reduced when the insured driver is aware of the fact that his or her driving is being monitored and that his or her good and safe driving will be rewarded. In accordance with the invention, insurance policies can now be written in a manner that punishes bad driving and/or rewards good driving, whether over time (as when the policy is renewed the premium can be adjusted) or instantaneously (as when the policy's adjustable premium terms take into account the monitoring of the insured vehicle). Indeed, a policy's adjustable premium terms could punish and/or reward the driver in real-time response to the manifest driving behavior. At the limit, a combination of adjustments to insurance premiums based on driving behavior as well as other measurable items such as mileage traveled per period, time of day that the vehicle is used, locations and roadways it is used on and a plethora of other such considerations that implicitly or explicitly result in a change of risk to the insurance company, could allow the insurance company to offer a dynamically variable insurance policy for typical or exceptionally long or short term periods.

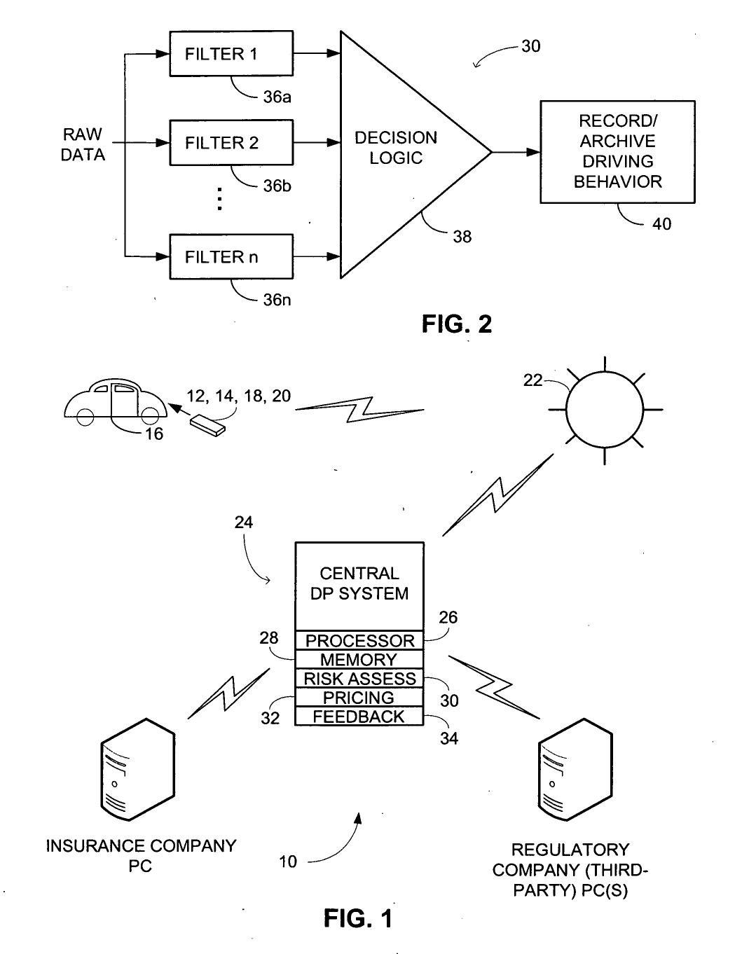

FIG. 1 is a system block diagram utilizing alternative Global Positioning Satellite (GPS) or vehicle-mounted sensors for driving behavior data collection. Invented system 10 includes one or more vehicle attitude sensing mechanisms such as a GPS mechanism 12 and/or one or more vehicle-mounted accelerometers 14 capable of generating raw or processed data relevant to the broadly defined absolute or relative “attitude” of a vehicle 16, e.g. its instantaneous or average position, elevation, orientation, direction, speed, acceleration, and the like. Those of skill in the art will appreciate that such data is sensed and at least temporarily recorded in a micro-memory 18, and optionally pre-processed by a microprocessor 20, within vehicle 16.

Such raw or processed data are then conveyed, e.g. via a wireless conveyance such as GPRS or WiFi, or a suitable satellite 22 that preferably is in geosynchronous orbit around the earth. (Those of skill in the art will appreciate that satellite 22 can be omitted in a given system architecture by providing a central DP site 24 that includes an integral and alternative unidirectional receiver or a bidirectional transmitter/receiver mechanism for receiving the raw or pre-processed data and for transmitting feedback and/or reporting data, e.g. a wide-area network (WAN) modem, the world-wide web or Internet, a local-area network (LAN) modem, a radio-frequency identification RFID system, or any suitable alternative. These and other alternatives might be more suitable for more controllable experiments or situations, for example, in which a relative few, geographically proximate or small-radius, vehicles and their drivers are being monitored. Such alternatives are contemplated as being within the spirit and scope of the invention.)

Satellite 22 conveys the data to a central data processing (DP) system 24 for (further) processing by a central processor 26 having a central memory 28. Those of skill in the art will appreciate that central site 24 concurrently receives and processes vehicle attitude data from plural ones of vehicle 16 so equipped. Thus, central DP system 24 is capable of collecting, recording and analyzing data from plural vehicles within its collection domain, which may be world-wide, fleet-wide, province-wide (geographically or jurisdictionally limited), or pool-wide (as by a defined pool or group of vehicles representing insured drivers that are similarly or differently situated, are insured by one or more insurers or underwriters, are of a given age group, etc. however defined).

Those of skill will also appreciate that real-time driving behavior data is derivable from such vehicle attitude data, and that derived driving behavior data can be used by one or more insurers or underwriters to manage insurance policy liability risks and/or policy premium costs. Deriving driving behavior data from vehicle attitude data typically would include deriving velocity and/or acceleration data from position and time data for the vehicle. Those of skill in the art will appreciate that such derivation of data would utilize well-known formulae, e.g. rate=distance/time and/or acceleration=rate/time, that would process raw or pre-processed vehicle attitude data into more refined data indicative of driver risk. For example, swerving or taking even a broad corner too fast can be determined from raw GPS or pre-processed acceleration data from one or more accelerometers by virtue of the pitch (which indicates braking), roll (which indicates steering) or even yaw (which indicates skidding) of the vehicle during a steering and/or braking process. Thus, relative risk is assessed. Absolute risk can be assessed by detecting from map databases provided by states, counties and cities the actual prevailing (de jure) speed limits corresponding to the GPS coordinates of the vehicle at the time.

In accordance with one embodiment of the invention, system 10, and more specifically, central DP system 24, includes a risk assessment engine 30, a driver's insurance pricing structure engine 32, and a dynamic feedback/reward engine 34. Generally, risk assessment engine 30 determines the risk of bad driving and/or health and/or safety issues for one or more given drivers based upon the raw or processed vehicle attitude data; pricing structure engine 32 determines a fair insurance premium pricing model—whether in real time and dynamic or periodic and retrospective—based upon the raw or processed vehicle attitude data; and dynamic feedback/reward engine 34 yields indicia or reporting—whether back to the driver or to oversight bodies and whether in real-time and dynamic or in the form of a periodic report—based upon the raw or processed vehicle attitude data.

Those of skill will appreciate that these functions can be segmented or combined differently or can reside in a different location within system 10, all within the spirit and scope of the invention. Moreover, one or more such functions can be omitted within the spirit and scope of the invention. For example, in an environmental or safety regulatory or other monitoring or compliance assurance application, central DP system 24 might include a risk management engine (providing data analysis and reporting functions) but neither an insurance pricing structure engine nor a dynamic feedback/reward engine.

FIGS. 2-4 are illustrative of the engines included in the invented system, in accordance with one embodiment of the invention.

Such a risk assessment function is illustrated in FIG. 2 as involving a risk assessment engine 30 that forms a part of central DP system 24. Risk management engine 30 in accordance with one embodiment of the invention includes one or more data filters 36a, 36b, . . . 36n that are statistics-based to aid in determining whether the driving behavior of one or more individual drivers or a fleet of drivers represent a lesser or greater risk of accident, injury, and/or the like. Those of skill will understand that such filters operate in accordance with programmable (and thus adjustable) parameters that are defined by the insurance or regulatory company as defining acceptable and unacceptable driving behavior norms. Such filters feed decision logic 38 that is implemented in software, for example, using look-up tables, weighted averaging, etc., as is known in connection with manual or mental risk assessment. In accordance with one embodiment of the invention, such filters operate automatically and in real time to make such risk assessment decisions. Finally, decision logic 38 outputs and archives a permanent or temporary record/archive 40 of the driving anomaly, incident, or otherwise notable behavior.

An example of the operation of filters 36a, 36b, . . . 36n and decision logic 38 can include the following. A single instance of rapid acceleration in any one of three dimensions of a given vehicle might be explained by relatively isolated circumstances, e.g. avoidance of a collision with a darting wild or feral animal, that are deemed beyond the driver's control. However, frequent ‘violations’ of the filter criteria and/or rules would result in the production of a report or feedback, e.g. a warning, to the offending driver. Such filters and decision logic can be comprehensive of environmental factors, e.g. wet roads/dense traffic, or regulatory factors, e.g. speed limits posted on roadways and uploaded to central DP system 24. In the case of an insurance company, it will be understood that the insurer's or underwriter's own actuarial expertise would establish such filter criteria and/or rules.

Filters 36a, 36b, . . . 36n and decision logic 38 alternatively can be any assemblage of functional blocks that takes raw or pre-processed vehicle position, elevation, direction, velocity, acceleration, weather, road condition, speed limit data, or the like, and processes it in accordance with defined criteria to assess the risk to him or herself of the driving behavior of the driver of the vehicle. In other words, these blocks can take other forms, can ignore data deemed spurious or otherwise unreliable, can involve calculations or computations using known or new formulae, can detect unsafe or erratic driving or driving indicative of drowsiness or being under the influence of alcohol or other drugs, can compare data to data ‘norms’, can compare data to de jure or de-rated speed limits, can compare data to multiple screening or filtering parameters such as average speed and acceleration, can permit without flagging certain driving anomalies while flagging others, can clock mileage and/or route traveled, can clock rest periods indicated by no or only nominal vehicular travel over a period of time, can distinguish incidental anomalies from bad driving, can distinguish occasional bad driving from chronic bad driving, etc. All such filtering and decision making are contemplated as being within the spirit and scope of the invention.

Those of skill in the art will appreciate that weather and road condition data, within the spirit and scope of the invention, can also be collected, e.g. by sensors mounted on vehicles and/or roadways and equipped to convey such data to a satellite or other central receiver. Moreover, other data pertaining to the vehicle itself, some of which may be provided already to the purchased vehicle's on-board microprocessor, can be collected, conveyed to the central receiver and used also in the decision making. For example, a vehicle's automatic braking system (ABS) data can be used to determine road conditions and perhaps driving behavior, since typically an ABS does not operate unless the vehicle otherwise would be skidding. Other collected data, e.g. tread conditions on the vehicle's tires, or brake pad wear, and the like, many of which are available in modem higher-end vehicles, can be used productively by filters 36a, 36b, . . . 36n and decision logic 38 (refer briefly to FIG. 2) to assist in more discerning decision making and driver behavior risk assessment and feedback/reward. Any and all such collectible data are contemplated as being collected and used in decision making, within the spirit and scope of the invention.

Those of skill will appreciate that data collected and analyzed and reported in accordance with the invention, within the spirit and scope of the invention, can be encrypted or otherwise secured and archived against inadvertent discovery by unauthorized third parties. For example, if the application is a good driving insurance reward for a ratepayer, then presumably law enforcement has no need to know the speed data collected in accordance with the invention. Thus, a compact between drivers and system providers such as licensees hereunder can ensure drivers that the collected data will be used only for its intended purpose and will neither be provided to third parties nor capable or being hacked by third parties.

In accordance with the invention as used in an insurance application, then, a data privacy/security protection mechanism is included so as to discourage and prevent the availability of any of the GPS and/or analytical information to unauthorized third parties. It is expected that the vehicle owner, approved driver(s), parent(s) and/or guardian(s) in the case of drivers under 18 years of age, the data processing agent(s) and the insurance company are all authorized parties, as are any other parties that are authorized by a combination of the vehicle owner and vehicle driver. In particular, the information is explicitly not intended for the use of law enforcement or other such parties except as may be required by law, which shall be disclosed in advance to the vehicle owner and driver.

The data privacy/security mechanism includes but is not limited to the following and shall include any additional process and technology elements that are added to the implementation from time to time and/or for specific solutions.
Proprietary identification and addressing mechanism, including mutual validation by the vehicle unit and the receiving computer of each other's authorized status prior to data transmission.
Storage and conversion of GPS data at the vehicle prior to transmission in a format that discourages interception or receipt of the data by an unintended or unauthorized recipient.
Secure and automated analysis of the data at the receiving location and continued secure storage and local transmission of the data utilizing state-of-the-art technology and processes for prevention of internal and external unauthorized access, including encryption, electronic certificates, etc.
Conversion of the information and its presentation in a human-readable form only upon validation of the identity of the recipient as an authorized user.
Typical computer and system level security maintained for both electronic access from the outside, such as enabled by firewalls, computer-to-computer authorization, etc. as well as physical access such as enabled by key cards, biometric identification, etc.
Well defined data access, storage, archival, retrieval and other policies and practices that augment the security of the data.

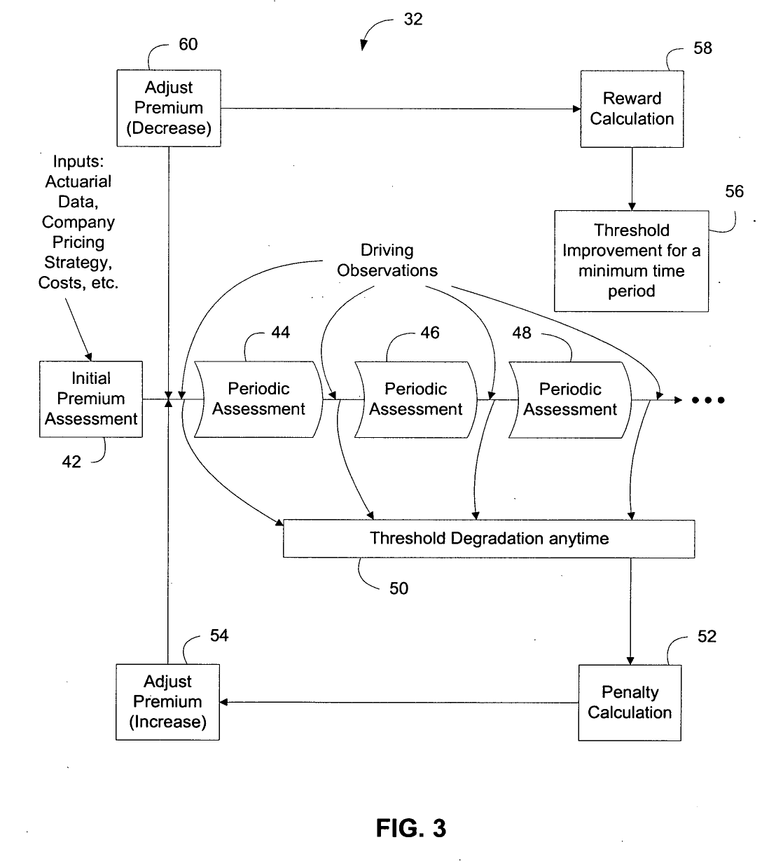

Turning now to FIG. 3, insurance pricing engine 32 will be described by reference to a schematic block diagram. The pricing engine includes an initial premium assessment block 42, wherein an initial pricing decision is made. Inputs to such decision making include actuarial data, state-regulated liability floors, insurance company pricing strategy (e.g. loss leader), costs, etc. As time passes during the life of any given insurance policy, many periodic assessments such as the three illustrated periodic assessments 44, 46, 48 based, for example, on driving behavior analysis in accordance with the invention, other driving observations, DMV histories or ratings, and/or other factors, are made. Typically, earlier periodic assessments might be bad, e.g., 44, 46 and/or 48, and thus there is observed a threshold degradation 50 during one or more of the early periodic assessment. At 52, then, a penalty calculation takes place, and at 54, the driver's degraded performance is negatively rewarded, i.e. punished, with a premium adjustment that represents an increase.

Typically, a driver's driving behavior improves over time, especially if it is being monitored and more especially it is being monitored in accordance with the invention. Thus, after one or more and more usually many periodic assessments, a threshold improvement 56 is observed for two or more successive periodic assessments, e.g. 46 and 48. A reward calculation 58 is then made and the driver's improved driving behavior is rewarded by an insurance premium adjustment 60 that represents a decrease. Thus, insurance pricing is calculated periodically or in real-time, e.g. substantially continuously, using the invented system and insured driver's driving behavior is monetarily rewarded or punished by a decrease or increase, respectively, in the insurance premium paid to the insurer.

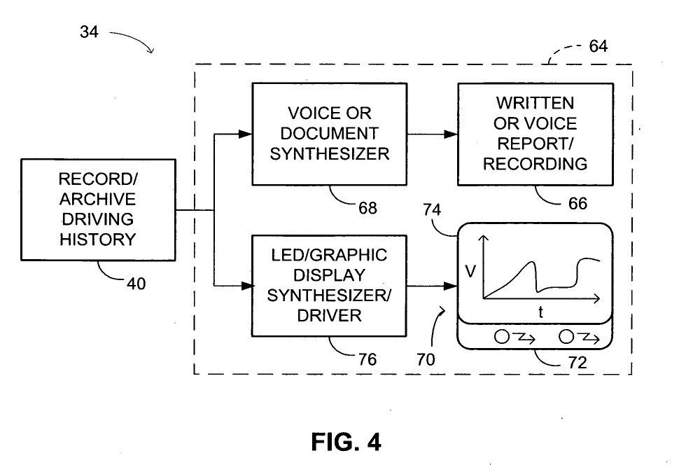

FIG. 4 is schematic block diagram of dynamic feedback/reward engine 34 that also forms a part of central DP system. Feedback/reward engine 34 will be understood by those of skill in the art to include a real-time process for giving a driver feedback and/or reward to his or her driving. First, those of skill in the art will appreciate that drivers who know they are being monitored are more likely to drive safely. This is human nature. Thus, engine 34 is optional and not limiting of the invention as described, illustrated and claimed herein.

Second, it will be appreciated that engine 34 can include nothing more than a record such as is generated at record/archive block 40 of FIG. 2. Such a record can take any desirable form such as simply identifying one or more of the vehicle; its registered owner and presumptive driver; its license number and/or vehicle identification number (VIN); the time of day; the vehicle location in terms of global position, e.g. latitude, longitude, and elevation coordinates; and the logged positive or negative assessment of risk from risk assessment engine 30. Such a record can be mailed in the form of a written or voice report 66 or can be otherwise conveyed to the driver at the driver's address of record, or report 66 can be mailed or otherwise conveyed to an appropriate agent such as the driver's parents or insurance agent.

Third, record/archive 40 can take the form of a feedback/reward 64 given in real-time response to the driving behavior, thereby to provide dynamic positive and/or negative reinforcement to the driver whose behavior is monitored. For example, if the driver is driving especially well for a period of time, a complimentary and/or encouraging voice recording 66 generated by a voice or written document synthesizer (the former using similar technology to that of the On Star™ tracking system) can be played or sent. Or the driver can be monetarily rewarded by an instantaneous insurance premium reduction effective so long as the safe driving continues. Such a continuous or real-time insurance premium adjustment system would reward good drivers based upon their actual good driving habits rather than on their admitted or alleged or no-news-is-good-news recorded driving habits as recorded by the Department of Motor Vehicles (DMV) by way of after-the-fact accident reports or driving record demerits or so-called “points.”

Such feedback/reward 64 alternatively or additionally can include disincentives to bad driving in the form of punishment or negative feedback or reinforcement. Thus, when a driver is determined to be driving unsafely, e.g. speeding around a corner, written or voice report/recording 66 could caution the driver to be more careful. Alternative means of negative reinforcement, as well as positive reinforcement, are contemplated as being within the spirit and scope of the invention.

For example, feedback/reward block 64 could light up a simple annunciator panel 70 within the dashboard light area of the vehicle. Qualitative feedback as simple as one or two colored LEDs 72 (e.g. green for good or go, red for bad or stop) can be used to give feedback to the driver about the good and bad aspects of his or her driving.

Or an alternative form of more complex digital or analogue can be given, e.g. a graph 74 could be displayed on an area of the dashboard (visible to the driver without diverting attention from the road) that gives quantitative feedback of the merit of the driver's behavior whether instantaneously, averaged, discrete, and/or over time (e.g. the illustrated velocity (V) over time (t) curve for the vehicle since a given road trip started. Observant readers may note that it appears the driver took off fast from his or her driveway, slammed on the brakes, failed to stop at an intersection choosing instead to roll through it, and then peeled out before inexplicably slowing, perhaps when a police officer was spotted. This driver gets no reward!). Such can be accumulated over desired time periods and can indicate to the driver or other passengers an automatic trend analysis of the driver's behavior. Those of skill will appreciate that panel 70 can be driven straightforwardly by a graphic display synthesizer/driver 76 similar to those found behind modern dashboards to control digital gauges.

Quite apart from monetary awards described and illustrated above in the insurance premium and pricing context, safe driving is its own reward. This is because of the great private and public toll exacted by unsafe driving. The cost of health care is rising, and the cost of emergency medical services including ambulance and urgent health care continues to go up. Even the vehicle accident mortality rate has its public cost as well, obviously, as its private cost. Thus, safe driving improvements occasioned by monitoring and reporting or feedback alone in accordance with the invention are reasonably expected to lower both the vehicle accident mortality rate and the emergency or long-term health care cost of vehicle accidents to both private and public persons and organizations.

Other uses of the invention include border security, hazardous waste tracking, idle/rest time enforcement under recent Federal statutes for long-haul drivers, and/or achievement of other vehicle and/or driver monitoring, environmental or safety compliance enforcement, regulatory, and/or risk management goals.

It will be understood that the present invention is not limited to the method or detail of construction, fabrication, material, application or use described and illustrated herein. Indeed, any suitable variation of fabrication, use, or application is contemplated as an alternative embodiment, and thus is within the spirit and scope, of the invention.

From the foregoing, those of skill in the art will appreciate that several advantages of the present invention include the following.

It is further intended that any other embodiments of the present invention that result from any changes in application or method of use or operation, method of manufacture, shape, size, or material which are not specified within the detailed written description or illustrations contained herein yet are considered apparent or obvious to one skilled in the art are within the scope of the present invention.

Finally, those of skill in the art will appreciate that the invented method, system and apparatus described and illustrated herein may be implemented in software, firmware or hardware, or any suitable combination thereof. Preferably, the method system and apparatus are implemented in a combination of the three, for purposes of low cost and flexibility. Thus, those of skill in the art will appreciate that the method, system and apparatus of the invention may be implemented by a computer or microprocessor process in which instructions are executed, the instructions being stored for execution on a computer-readable medium and being executed by any suitable instruction processor.

Accordingly, while the present invention has been shown and described with reference to the foregoing embodiments of the invented apparatus, it will be apparent to those skilled in the art that other changes in form and detail may be made therein without departing from the spirit and scope of the invention as defined in the appended claims.

It will be understood that the present invention is not limited to the method or detail of construction, fabrication, material, application or use described and illustrated herein. Indeed, any suitable variation of fabrication, use, or application is contemplated as an alternative embodiment, and thus is within the spirit and scope, of the invention.

It is further intended that any other embodiments of the present invention that result from any changes in application or method of use or operation, configuration, method of manufacture, shape, size, or material, which are not specified within the detailed written description or illustrations contained herein yet would be understood by one skilled in the art, are within the scope of the present invention.

Finally, those of skill in the art will appreciate that the invented method, system and apparatus described and illustrated herein may be implemented in software, firmware or hardware, or any suitable combination thereof. Preferably, the method system and apparatus are implemented in a combination of the three, for purposes of low cost and flexibility. Thus, those of skill in the art will appreciate that embodiments of the methods and system of the invention may be implemented by a computer or microprocessor process in which instructions are executed, the instructions being stored for execution on a computer-readable medium and being executed by any suitable instruction processor.

Accordingly, while the present invention has been shown and described with reference to the foregoing embodiments of the invented apparatus, it will be apparent to those skilled in the art that other changes in form and detail may be made therein without departing from the spirit and scope of the invention as defined in the appended claims.

I claim:

1. A network system for monitoring driving behavior, comprising:
one or more vehicle-mountable motion sensing mechanisms configured to generate a plurality of data relevant to vehicle moving attitude indicative of one or more of manual and mental risks for a vehicle operator, the plurality of data wirelessly transmittable;
a central data processing system for collecting the plurality of data transmitted from the one or more motion sensing mechanisms;
a risk assessment engine operatively coupled with the central data processing system and operable to analyze the one or more of manual and mental risks based on the collected plurality of data; and
a feedback engine operatively coupled with the central data processing system and operable to yield indicia based on the analyzed data, the indicia reportable to one or more of the vehicle operator and an authorized data recipient, the feedback engine comprising
a reward engine configured to reward one or more of good and improved driving behavior of the vehicle operator.

2. The network system of claim 1, in which the plurality of data relevant to vehicle moving attitude defines a characteristic motion profile of a vehicle.

3. The network system of claim 2, in which the one or more motion sensing mechanisms includes a Global Positioning System (GPS)-based mechanism operable to generate a plurality of raw data relevant to the characteristic motion profile of a vehicle.

4. The network system of claim 2, in which the one or more motion sensing mechanisms includes vehicle-mountable accelerometers operable to generate a plurality of pre-processed data relevant to the characteristic motion profile of a vehicle.

5. The network system of claim 2, wherein the risk assessment engine includes one or more data filters operable to capture real-time parameters for determining driving behavior of the vehicle operator, and wherein the one or more data filters are configured to generate real-time driving behavior data.

6. The network system of claim 5, wherein the risk assessment engine further includes a decision logic device configured to assess the one or more of manual and mental risk based on the real-time driving behavior data against predefined criteria including state-regulated liability floors, regional statistics, actuarial vehicle data, personal driving history, and DMV ratings, and wherein the decision logic device generates reportable decision data relevant to the vehicle operator.

7. The network system of claim 6, further comprising a database configured to store the reportable decision data from the decision logic device.

8. The network system of claim 7, in which the feedback engine comprises one or more synthesizers configured to receive the decision data stored in the database.

9. The network system of claim 8, in which the one or more synthesizers are configured to yield the indicia, the indicia including real-time decision data deliverable in one or more of a audio and a visual format to the one or more of the vehicle operator and an authorized data recipient.

10. The network system of claim 8, in which the one or more synthesizers are configured to deliver the real-time decision data displayable by one or more of a LED panel and a graphic display in an operator's console region of the vehicle.

11. The network system of claim 9, in which the one or more of the vehicle operator and an authorized data recipient comprise one or more of the vehicle operator, insurance companies, regulatory bodies, commercial fleet management, and law enforcement.

12. The network system of claim 11, further comprising:
a driver's insurance pricing structure engine operatively coupled with the risk assessment engine and operable to determine an insurance premium pricing model, based on the reported decision data.

13. The network system of claim 12, in which the pricing structure engine includes:
an initial premium assessment device configured to determine the initial premium based on one or more of actuarial data, insurer pricing strategy, and cost analysis;
a dynamic periodic premium adjustment device configured to determine one or more threshold premium adjustments based on one or more of the real-time driving behavior data and DMV ratings of the vehicle operator; and
a calculating device configured to determine whether the one or more threshold premium adjustments are warranted and to calculate selectively based thereon a reward for the one or more of good and improved driving behavior, and a penalty for bad driving behavior.

14. The system of claim 1, further comprising:
a data security mechanism configured to guard against transmission of data to an unauthorized recipient, the data including one or more of the real-time data relevant to vehicle moving attitude and the decision data deliverable from the central data processing system.

15. The system of claim 14, wherein the data security mechanism comprises an encryption system configured to perform one or more of encoding and archiving the data in secured storage, securing the data by ID plus password, and guarding the data against unauthorized physical access.

16. A method for monitoring driving behavior associated with driving condition improvement for greater road safety, comprising:
activating one or more vehicle-mountable sensing mechanisms;
collecting a plurality of data from the one or more vehicle-mountable sensing mechanisms, the plurality of data relevant to vehicle moving attitude indicative of one or more of manual and mental risks of a vehicle operator;
assessing the one or more manual and mental risks against one or more of predefined criteria, statistics, DMV ratings, and real-time driving behavior data;
recording the risk assessment data;
providing a feedback mechanism for delivering the recorded risk assessment data to the vehicle operator; and
coupling a reward mechanism to the feedback mechanism for encouraging good driving behavior.

17. The method of claim 16, wherein the activation of the one or more vehicle-mountable sensing mechanisms comprises starting a vehicle engine, and wherein the activation includes keeping the vehicle engine running.

18. The method of claim 17, wherein the collection of a plurality of data relevant to vehicle moving attitude comprises providing one or more data filters to capture real-time parameters relating to one or more of excessive acceleration, frequent over-limit speeding, and abnormal movement of a vehicle.

19. The method of claim 18, wherein the assessment of the one or more of manual and mental risks comprises analyzing the real-time parameters against predefined criteria including state-regulated liability floors, regional statistics, actuarial vehicle data, personal driving history, and DMV ratings.

20. The method of claim 19, wherein the assessment of the manual and mental risks further comprises defining driving behavior based on the analyzed real-time parameters, and wherein the defining driving behavior includes generating real-time driving behavior data reportable to the one or more of the vehicle operator and an authorized data recipient.

21. The method of claim 20, wherein the assessment of the manual and mental risks further comprises transmitting the real-time driving behavior data for data recording.

22. The method of claim 21, wherein the recording the risk assessment data comprises receiving the transmitted real-time driving behavior data and storing thereof in a database retrievable by an authorized data recipient, and wherein the authorized data recipient includes the vehicle operator.

23. The method of claim 22, wherein the providing a feedback mechanism comprises enabling one or more synthesizers to deliver the driving behavior data to the authorized recipient, and wherein the enabling one or more synthesizers comprises yielding indicia of the real-time driving behavior and displaying thereof in one or more of audio and visual formats on a media readily available to the authorized recipient.

24. The method of claim 23, wherein the coupling a reward mechanism to the feedback mechanism comprises configuring an insurance pricing structure relevant to the vehicle operator, and wherein the configuring insurance pricing structure comprises determining one or more threshold premium adjustments responsive to the real-time driving behavior data.

25. The method of claim 24, wherein the coupling a reward mechanism to the feedback mechanism further comprises providing monetary incentives to the vehicle operator based on positive feedback data, and wherein the providing incentives includes reducing insurance premiums for the vehicle operator.

26. The method of claim 16, further comprising:
providing a data security system for ensuring safe transmission of the driving behavior data to the one or more of the vehicle operator and an authorized data recipient.

27. The method of claim 25, wherein the ensuring safe transmission of the driving behavior data comprises encoding and archiving the data in secured storage, securing the data by ID plus password, and guarding the data against unauthorized physical access.
